(19) United States
(12) Patent Application Publication
(10) Pub. No.: US 2005/0110204 A1
(43) Pub. Date: May 26, 2005

(54) Reconfigurable mechanical fixturing pallets for assembly lines

(76) Inventors: Chi-Hung Shen, Troy, MI (US); Yhu-Tin Lin, Rochester Hills, MI (US)

Correspondence Address: Kathryn A. Marra;General Motors Corporation, Legal Staff - Mail Code 482-C23-B21, P.O. Box 300, Detroit, MI, 48265-3000, US

(21) Appl. No.: 10/721,814

(22) Filed: Nov. 25, 2003

(51) Int. Cl. B23Q 3/00

(52) U.S. Cl. 269/309

(57) ABSTRACT

A reconfigurable pallet that supports a structure includes a pallet base and at least one track formed in the pallet base. A plurality of modular stanchions are supported on the pallet base and slidably engage the at least one track to selectively position the modular stanchions along x and y axes relative to a top surface of the pallet base. The modular stanchions each include a support element that has a height along a z axis that is transverse to the x and y axes. The support element supports the structure.

### FIELD OF THE INVENTION

The present invention relates to assembly lines, and more particularly to a reconfigurable pallet for an assembly line.

### BACKGROUND OF THE INVENTION

The advent of assembly lines enabled rapid, mass production of products, reduced product cost. Assembly lines typically include multiple operation stages and component, material or sub-assembly inputs. Typically, a base structure is supported on a pallet that is transferred through the assembly line. Operations are performed on the base structure at the various operation stages to produce an end product. A single assembly line can be used to assemble varying product types. For example, an assembly line can be configured to assemble a first engine type and then reconfigured to assemble a second, different engine type.

Typical pallets include upward extending stanchions that are fixed to a base. The stanchions include support elements that support the base structure. Each stanchion is fixed in a specific location on the base and includes a fixed height to vertically position the support element at a required support location. Traditionally, a specific pallet corresponds to a specific product type. For example, for the first and second engine types introduced above, a first pallet includes a stanchion configuration that supports the first engine type. A second pallet includes a different stanchion configuration to support the second engine type.

Traditional pallets are not interchangeable across product types because each pallet is specifically designed to support a specific product type. Because a unique pallet is required for each product type production costs increase. Such production costs include costs associated with designing, manufacturing and purchasing of each pallet type. Further, capital investment and longer lead times are required when transitioning between product types.

### SUMMARY OF THE INVENTION

Accordingly, the present invention provides a reconfigurable pallet that supports a structure. The reconfigurable pallet includes a pallet base and at least one track formed in the pallet base. A plurality of modular stanchions are supported on the pallet base and slidably engage the at least one track to selectively position the modular stanchions along x and y axes relative to a top surface of the pallet base. The modular stanchions each include a support element that has a height along a z axis that is transverse to the x and y axes. The support element supports the structure.

In another feature, the x and y axes are parallel to a top surface of the pallet base and the z axis is perpendicular to the x and y axes.

In one feature, the support element is movable along the z axis to adjust the height.

In another feature, each of the modular stanchions further comprises a support cylinder that is selectively actuated to move the support element to a position along the z axis. A hydraulic pump is in fluid communication with the support cylinder and is operable to adjust a hydraulic pressure within the support cylinder to move the support element along the z axis.

In still another feature, each of the modular stanchions further comprises a stanchion base that supports the support element. The pallet base can include a screw-drive that engages the stanchion base. Rotation of the screw-drive induces linear motion of the modular stanchion along the track.

In yet another feature, the at least one track extends from a center point of the pallet base. The pallet base can further include a rotatable member that is rotatable about the center point and that supports the at least one track.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a generic assembly line;

FIG. 2 is a schematic illustration of a reconfigurable pallet including modular stanchions;

FIG. 3 is a schematic illustration of a modular stanchion of the reconfigurable pallet of FIG. 2;

FIG. 4 is a schematic illustration of a fixed height modular stanchion;

FIG. 5 is a top view of the reconfigurable pallet illustrating tracks or rails to configure the modular stanchions;

FIG. 6 is a side view of a modular stanchion of the reconfigurable pallet of FIG. 5 illustrating a screw drive to shift the modular stanchions;

FIG. 7A is a side view of a modular stanchion of the reconfigurable pallet of FIG. 5 illustrating a slide engagement to shift the modular stanchions;

FIG. 7B is a side view of the modular stanchion of FIG. 5 illustrating engagement between the modular stanchion and a rail of the reconfigurable pallet; and

FIG. 8 is a top view of the reconfigurable pallet illustrating an alternative technique using tracks or rails and polar rotation to configure the modular stanchions.

### DETAILED DESCRIPTION OF THE PREFERRED EMBODIMENTS

The following description of the preferred embodiments is merely exemplary in nature and is in no way intended to limit the invention, its application, or uses.

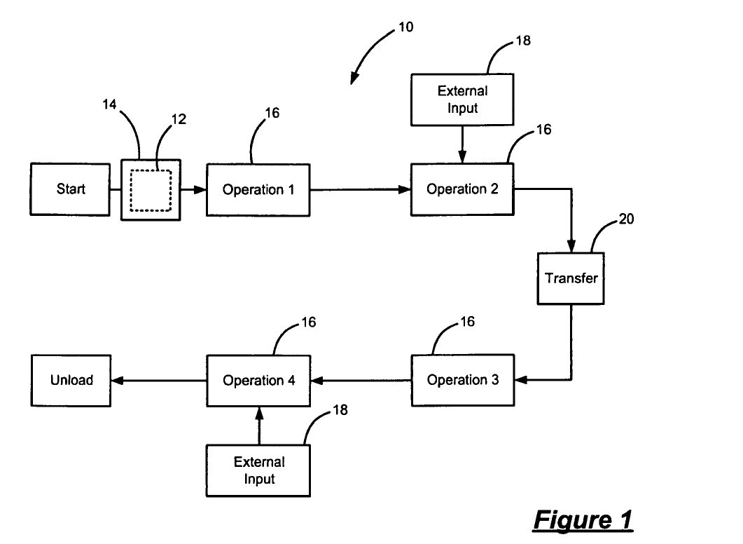

Referring now to FIG. 1, a generic assembly line 10 is schematically illustrated. The assembly line 10 is illustrative of numerous types of assembly lines used across various industries. For example, the generic assembly line 10 can depict an engine, a chassis, a vehicle sub-assembly or any type of vehicle oriented assembly line. More broadly, the generic assembly line 10 can depict any type of assembly line across all industries.

A base structure 12 (shown in phantom) of a “to be assembled” product is moved through the assembly line 10 on a reconfigurable pallet 14. The generic assembly line 10 includes multiple operation stages 16. Single or multiple operations are performed on the product at each operation stage 16. Such operations include, but are not limited to assembling a component, welding, treating the base structure (e.g., heat treatment), applying sealant, adhesive or the like and packaging the assembled product for shipping. Other inputs 18 are also included such as a component input, a sub-assembly input or a material input. A transfer 20 is also provided to transfer the reconfigurable pallets 14 to other parts of the assembly line 10. It is appreciated that the assembly line 10 is merely exemplary in nature and can vary in configuration, the number of operation stages 16, the number and location of component, sub-assembly or material inputs 18, transfers 20 and the like.

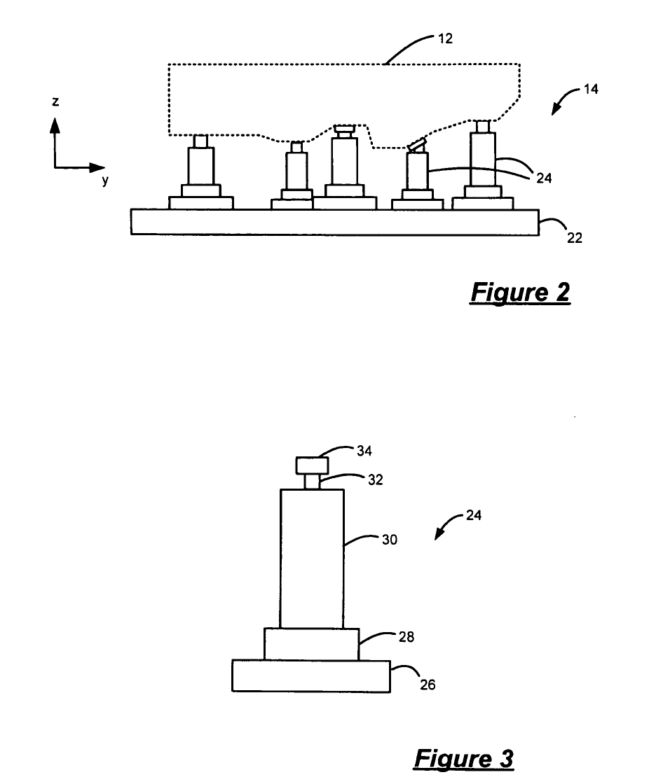

Referring now to FIG. 2, the reconfigurable pallet 14 is illustrated. The reconfigurable pallet 14 includes a base 22 that supports multiple modular stanchions 24. The base material corresponds to the loads it is designed to carry. For example, the base 22 can be made of a strong metal material to support heavier products such as an engine. Other materials can be used to construct the base 22. The material is selected based on the type of load that it is required to support. The multiple modular stanchions 24 support the base structure 12 (shown in phantom) of a product as it is transferred through the various operation stages 16 of the assembly line 10. The product is representative of a generic product and can be any product that is assembled or treated along an assembly line. The modular stanchions 24 can be attached to or otherwise support the product.

As explained in further detail below, the modular stanchions 24 are adjustable to support various product types. The modular stanchions 24 can move along x and y axes (see FIG. 5) and also along a z axis (see FIG. 2) transverse to the x and y axes. As further shown in FIG. 2, the positioning of the base structure 12 or any portion of such structure is adjustable in all three directions, x, y and z. For example, the modular stanchions 24 can be arranged in a first configuration to support one engine type for assembly in the assembly line 10. The modular stanchions 24 can be reconfigured in a second configuration to accommodate a second engine type or another product altogether. In this manner, a single pallet 14 is reusable across assembly lines 10 and across products types.

Referring now to FIG. 3, an exemplary modular stanchion 24 is shown. The modular stanchion 24 includes a stanchion base 26, a fluid pump 28 and a support cylinder 30. The stanchion base 26 rests on the pallet base 22 and is selectively positionable along the x and y axes. The fluid pump 28 is supported on the stanchion base 26 and is in fluid communication with the support cylinder 30. The support cylinder 30 includes a rod 32 that has a support element 34 attached thereto. The rod 32 is laterally adjustable by varying the fluid pressure within the support cylinder 30.

The fluid pump 28 can be one of several types of fluid pumps known in the art including, but not limited to, a hydraulic screw-pump. Although not illustrated, a traditional hydraulic screw pump includes a hollow metal cylinder having a small opening at a closed end and a leak-free plunger screw-actuated at an open end. The small opening is connected to a hydraulic device such as a the support cylinder 30. When the plunger-screw is rotated clockwise, it moves axially inward, pressurizing the hydraulic fluid to actuate the hydraulic device. When the plunger-screw is rotated counterclockwise, it moves axially outward and thus decreases the fluid pressure and deactivates the hydraulic device. It is anticipated that the reservoir of oil inside the screw-pump can serve several hydraulic devices.

Actuation of the support cylinder 30 using the fluid pump 28 results in adjustment of the rod 32. Adjustment of the rod 32 enables positioning of the support element 34 along the z axis. In the event that the z axis position is outside of the range of the support cylinder 30, a gauge block or spacer (not shown) having an appropriate thickness can be implemented to raise the support cylinder 30. Alternatively, another support cylinder 30 having a longer stroke can be used.

The support elements 34 can vary in size and style between the modular stanchions 24. The support elements 34 include, but are not limited to, buttons, round locators, diamond locators and pads. The support elements 34 can be interchanged on the rods 32 of the support cylinders 30 and can be fixedly attached to the base structure 12 to secure the base structure 12 to the reconfigurable pallet 14. Additionally, such as in the case of a pad, the base structure 12 can rest on the support elements 34, held in place by gravity. It is also anticipated that the support elements 34 can be articulated in various directions to accommodate the contours of the base structure 12.

Although the exemplary modular stanchion 24 includes hydraulic adjustment of the support element 34 along the z axis, it is anticipated that other mechanisms can be incorporated to achieve lateral adjustment (i.e., along the z-axis) of the support element 34. For example, a mechanical mechanism such as a rack and pinion system can be employed to position the support element 34 along the z axis. The rack and pinion system can be driven manually or by a rotating tool. Alternatively, an adjustable tube that is slidable along the z axis and lockable in position by a pin can be implemented.

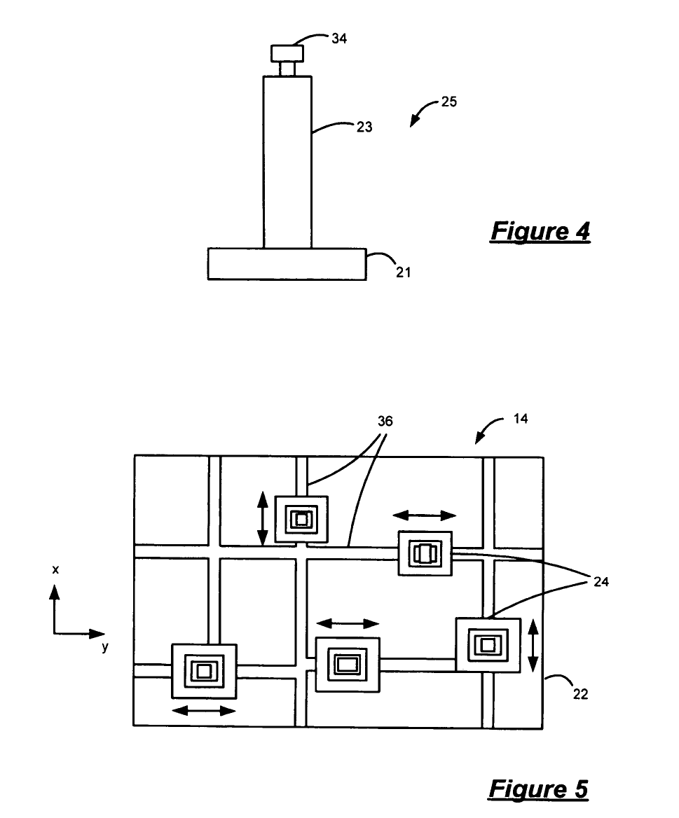

With reference to FIG. 4, it is further anticipated that fixed height modular stanchions 25 can be implemented. The fixed height stanchions 25 each include a stanchion base 21, a support column 23 and the support element 34. Although the support elements 34 can be interchanged, the height of the support column 23 is fixed. This height can vary from stanchion 25 to stanchion 25. For a given product type the z-axis coordinates for the various support elements 34 can be predefined. The fixed height stanchions 25 having the required z-axis height can be selected from a pool of fixed height stanchions 25 and can be mounted to the pallet base 22 to support the product.

Referring now to FIG. 5, a top view of a reconfigurable pallet 14 is illustrated. The modular stanchions 24 slidably engage tracks 36 to enable rectilinear adjustment of the modular stanchions 24 along the x and y axes. It will be appreciated that movement in the x and y directions refers to movement in any direction in the x-y plane. It is also appreciated that the number of tracks 36 and their locations can vary as design requirements dictate. The modular stanchions 24 can be laterally adjusted mechanically or manually. An anchor mechanism (not shown) can be included to anchor the modular stanchion in position along the tracks 36. For example, the anchor mechanism is disengaged to enable sliding of the modular stanchion 24 along the track 36 and is engaged to prohibit linear motion of the modular stanchion 24 along the track 36. It is also anticipated that the fixed height modular stanchions 25 can similarly engage the tracks 36.

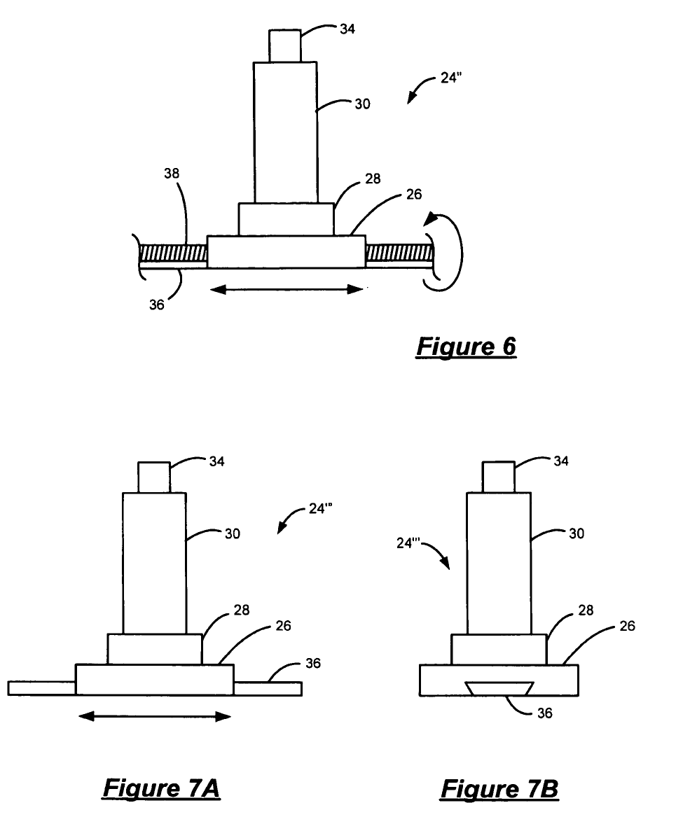

Referring now to FIG. 6, yet another exemplary modular stanchion 24″ is illustrated. The exemplary modular stanchion 24″ engages the track 36 and is mechanically actuated to move along the track 36. More specifically, a screw-drive 38 is implemented to induce linear movement of the modular stanchion 24″ along the track 36. The screw-drive 38 is driven by a motor (not shown) or a hand crank (not shown). As the screw-drive 38 is caused to rotate in a first rotational direction, the modular stanchion 24″ moves along the track 36 in a first linear direction. As the screw-drive 38 is caused to rotate in a second rotational direction, the modular stanchion 24″ moves along the track 36 in a second linear direction. The screw-drive 38 is merely exemplary of a mechanical system implemented to induce movement of the modular stanchions 24″. It is also anticipated that the screw-drive can be implemented with the fixed height modular stanchions 25.

Referring now to FIGS. 7A and 7B, still another exemplary modular stanchion 24′″ illustrates an interface between the stanchion base 26 and an exemplary track 36. The exemplary track 36 includes a dovetail cross-section that slidably engages a dovetail notch 40 formed through the stanchion base 26. The dovetail interface prohibits the modular stanchion 24′″ from jumping off the track 36. As described above, the modular stanchion 24′″ can be moved along the track manually or by mechanical means. It is also anticipated that the track interface can be implemented with the fixed height modular stanchions 25.

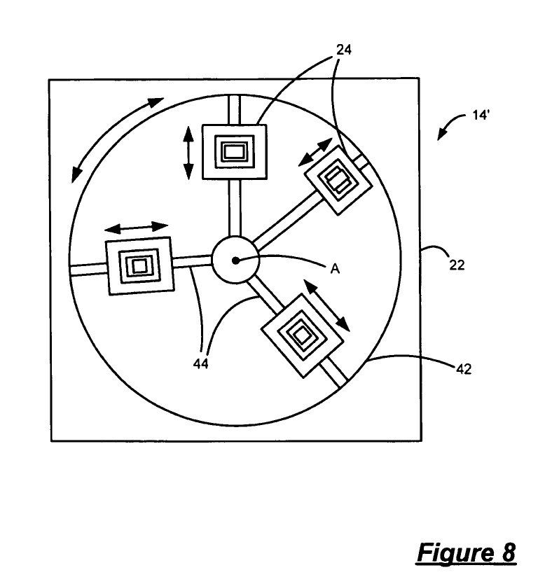

Referring now to FIG. 8, another exemplary reconfigurable pallet, indicated as 14′, illustrates a polar track configuration for adjusting the position of the modular stanchions 24,25 in the x-y plane. The pallet base includes a circular section 42 that is rotatable about a central axis A. A series of tracks 44 are formed on the circular section 42 and radially extend from the axis A. It is appreciated that the number of tracks 44 can vary as design requirements dictate. The modular stanchions 24,25 slidably engage the tracks 44 and are induced to move either manually or mechanically, as described above. A combination of linear movement of the modular stanchions along the tracks and rotational movement of the circular section 42 about the axis A enables each modular stanchion 24,25 to be located in a desired position in the x-y plane.

Prior to use in the assembly line 10, the reconfigurable pallet 14 is configured to support the specific base structure 12 and product to be assembled. More specifically, the x, y and z positions of each modular stanchion 24,25 are selected or adjusted and the support element 34 geometries are configured for the specific support requirements of the base structure 12. A dedicated set-up station (not shown) includes a simple computer numerically controlled (CNC) x-y table. The set-up station positions the modular stanchions 24,25 at the appropriate x-y coordinates. The stanchion bases 26 are locked in position as described above. An operator adjusts the z-coordinate of each modular stanchion 24, in the case of a height adjustable modular stanchion. Adjustment of the z-coordinate can be achieved hydraulically or manually, as described above. The operator re-checks the x, y and z coordinates of each modular stanchion 24,25 then releases the reconfigurable pallet 14 for use in the assembly line 10.

The reconfigurable pallet 14 of the present invention enables multiple spatial positioning for locating pins or support pads. Thus, the reconfigurable pallet 14 is adjustable to accommodate various product types. In this manner, significant savings is obtained by reducing design, engineering, manufacturing and purchasing of pallets for each product type. Further savings are achieved in the form of reduced capital investment and lead-time during transition between products.

The description of the invention is merely exemplary in nature and, thus, variations that do not depart from the gist of the invention are intended to be within the scope of the invention. Such variations are not to be regarded as a departure from the spirit and scope of the invention.

1. A reconfigurable pallet that supports a structure, comprising:
a pallet base;
at least one track formed in said pallet base;
a plurality of modular stanchions that are supported on said pallet base and slidably engage said at least one track to selectively position said modular stanchions along x and y axes relative to a top surface of said pallet base, said modular stanchions each including a support element that has a height along a z axis that is transverse to said x and y axes, said support element supporting said structure.

2. The reconfigurable pallet of claim 1 wherein said x and y axes are parallel to a top surface of said pallet base and said z axis is perpendicular to said x and y axes.

3. The reconfigurable pallet of claim 1 wherein said support element is movable along said z axis to adjust said height.

4. The reconfigurable pallet of claim 3 wherein each of said modular stanchions further comprises a support cylinder that is selectively actuated to move said support element to a position along said z axis.

5. The reconfigurable pallet of claim 4 further comprising a hydraulic pump in fluid communication with said support cylinder and operable to adjust a hydraulic pressure within said support cylinder to move said support element along said z axis.

6. The reconfigurable pallet of claim 1 wherein each of said modular stanchions further comprises a stanchion base that supports said support element.

7. The reconfigurable pallet of claim 6 wherein said pallet base further includes a screw-drive that engages said stanchion base wherein rotation of said screw-drive induces linear motion of said modular stanchion along said track.

8. The reconfigurable pallet of claim 1 wherein said at least one track extends from a center point of said pallet base.

9. The reconfigurable pallet of claim 8 wherein said pallet base further includes a rotatable member that is rotatable about said center point and that supports said at least one track.

10. A pallet that is configurable to support first structure and reconfigurable to support a second structure, comprising:
a pallet base;
at least one track formed in said pallet base; and
a plurality of modular stanchions that slidably engage said at least one track to selectively move along x and y axes relative to a top surface of said base, said modular stanchions each including a support element that is has a height defined along a z axis transverse to said x and y axes, said support element having a first position to support said first structure and having a second position to support said second structure.

11. The pallet of claim 10 wherein said support element is movable along said z axis to adjust said height.

12. The pallet of claim 10 wherein each of said modular stanchions further comprises a support cylinder that is selectively actuated to move said support element to a position along said z axis.

13. The pallet of claim 12 further comprising a hydraulic pump in fluid communication with said support cylinder and operable to adjust a hydraulic pressure within said support cylinder to move said support element along said z axis.

14. The pallet of claim 10 wherein each of said modular stanchions further comprises a stanchion base that supports said support element.

15. The pallet of claim 14 wherein said pallet base further includes a screw-drive that engages said stanchion base wherein rotation of said screw-drive induces linear motion of one of said modular stanchions.

16. The pallet of claim 10 wherein said track extends from a center point of said pallet base and that engages said stanchion base for movement of said stanchion base across said x and y axes.

17. The pallet of claim 16 wherein said pallet base further includes a rotatable member that is rotatable about said center point and that supports said track.

18. A reconfigurable pallet that is configurable to support multiple structures, comprising:
a pallet base;
at least one track formed in said pallet base; and
a modular stanchion that comprises:
a stanchion base that is slidably supported on said at least one track and that is movable along x and y axes relative to a top surface of said pallet base; and
a support element that is supported on said stanchion base and that has a height transverse to said x and y axes along a z axis, said support element having a first position to support a first structure and a second position to support second structure.

19. The reconfigurable pallet of claim 18 wherein said support element is movable along said z axis to adjust said height.

20. The reconfigurable pallet of claim 19 wherein said modular stanchion further comprises a support cylinder that is selectively actuated to move said support element to a position along said z axis.

21. The reconfigurable pallet of claim 20 further comprising a hydraulic pump in fluid communication with said support cylinder and operable to adjust a hydraulic pressure within said support cylinder to move said support element along said z axis.

22. The reconfigurable pallet of claim 18 wherein said base further includes a screw-drive that engages said stanchion base wherein rotation of said screw-drive induces linear motion of said modular stanchion along said track.

23. The reconfigurable pallet of claim 18 wherein said track extends from a center point of said pallet base and that engages said stanchion base for movement of said stanchion base across said x and y axes.

24. The reconfigurable pallet of claim 23 wherein said pallet base further includes a rotatable member that is rotatable about said center point and that supports said track.

25. An assembly line for assembling a product, comprising:
a plurality of operation stages; and
a pallet that supports a base structure of said product and carries said base structure between said operating stages, comprising:
a pallet base;
at least one track formed in said pallet base;
a stanchion base that is supported on said pallet base and that is movable along x and y axes relative to a top surface of said pallet base; and
a support element that is supported on said stanchion base and that has a height transverse to said x and y axes along a z axis, said support element having a first position to support said base structure.

26. The assembly line of claim 25 wherein said support element is movable along said z axis to adjust said height.

27. The assembly line of claim 26 wherein said pallet further comprises a support cylinder that is supported by said stanchion base and that is selectively actuated to move said support element to a position along said z axis.

28. The assembly line of claim 27 further comprising a hydraulic pump in fluid communication with said support cylinder and operable to adjust a hydraulic pressure within said support cylinder to move said support element along said z axis.

29. The assembly line of claim 25 wherein said pallet base further includes a screw-drive that engages said stanchion base wherein rotation of said screw-drive induces linear motion of said modular stanchion along said track.

30. The assembly line of claim 25 wherein said track extends from a center point of said pallet base and that engages said stanchion base for movement said stanchion base across said x and y axes.

31. The assembly line of claim 30 wherein said pallet base further includes a rotatable member that is rotatable about said center point and that supports said track.
